(19) United States
(12) Patent Application Publication
(10) Pub. No.: US 2015/0296808 A1
(43) Pub. Date: Oct. 22, 2015

(54) DEVICES, SYSTEMS, AND METHODS FOR FILLING DOUGHNUT HOLES

(71) Applicant: Belshaw Bros., Inc., Auburn, WA (US)

(72) Inventors: Michael J. Ploof, Puyallup, WA (US); Christopher Brock, Auburn, WA (US); William James Setter, Mercer Island, WA (US)

(21) Appl. No.: 14/693,638

(22) Filed: Apr. 22, 2015

Related U.S. Application Data
(60) Provisional application No. 61/982,756, filed on Apr. 22, 2014.
(60) Provisional application No. 62/080,111, filed on Nov. 14, 2014.

(51) Int. Cl. A21C 15/00; A23P 1/08; B08B 9/02; B65G 17/12

(52) U.S. Cl. CPC A21C 15/007; B65G 17/12; A23P 1/086; B08B 9/02

(57) ABSTRACT

The present disclosure is directed towards systems, devices, and methods for filling doughnut holes. The system comprises a conveyor system that transports doughnut holes between at least a loading section, a culling section, and an injection section. The conveyor system includes a plurality of links coupled together to form a belt. The loading section includes a feeding device that feeds doughnut holes onto the conveyor system. The culling section includes a culling bar that culls excess doughnut holes from the conveyor. The injection section includes an injector system that injects feeds doughnut holes with a filling.

### BACKGROUND

1. Technical Field

The present disclosure relates to systems, devices, and methods for filling doughnut holes, and more particularly, to automated systems and methods, for loading and separating doughnut holes, injecting the doughnut holes with a filling, and discharging the filled doughnut holes for additional handling, sorting, and packaging.

2. Background of the Invention

Doughnuts and pastries are a mainstay of breakfasts all around the world. Bakers have continually sought to innovate and provide increased value and variety to their goods, including doughnuts. Bakers have developed different sized and shaped doughnuts. They also started applying toppings to doughnuts and injecting fillings into doughnuts. Bakers can provide doughnuts in a number of shapes from the traditional toroidal or ring shape, to the doughnut hole, the flattened sphere, and the fritter, among others.

Bakers traditionally use flattened, sphere-shaped doughnuts in their filled doughnut products, but recent consumer demand has led bakers to begin filling doughnut holes with creams, jellies, jams, and other fillings. The small size and spherical shape of doughnut holes has so far prevented the automated filling of doughnut holes. Bakers currently spend a great deal of time manually filling each doughnut hole.

The manual process requires bakers to pick up each doughnut hole, place it on an injector, inject the filling, place each filled doughnut hole in a package, and then repeat the process as long as necessary to meet customer demand.

### BRIEF SUMMARY

What bakers need is a simple automated process for handling the unfilled doughnut, injecting it with filling, and providing the filled doughnut hole to packaging or other downstream equipment.

The present disclosure is directed towards systems, devices, and methods for filling doughnut holes. The system comprises a conveyor system that transports doughnut holes between at least a loading section, a culling section, and an injection section. The conveyor system includes a plurality of links coupled together to form a belt. The loading section includes a feeding device that feeds doughnut holes onto the conveyor system. The culling section includes a culling bar that culls excess doughnut holes from the conveyor. The injection section includes an injector system that injects doughnut holes with a filling.

The present disclosure is also directed towards a method of filling a doughnut hole. The method comprises configuring a doughnut hole filling machine for operation, loading doughnut holes onto a conveyor, culling excess doughnut holes from the conveyor, transporting the doughnut holes to an injection section, and filling the doughnut holes with filling.

### BRIEF DESCRIPTION OF THE SEVERAL VIEWS OF THE DRAWINGS

FIG. 1 is a flow chart showing one embodiment of a doughnut hole filling process;

FIG. 2A is an isometric view of a doughnut hole filling system;

FIG. 2B is a cross-sectional view of the doughnut hole filling system of FIG. 2A;

FIG. 3 is a side view of a portion of the of the doughnut hole filling system of FIG. 2A;

FIG. 4A is an isometric view of a conveyor link of the doughnut hole filling system of FIG. 2A;

FIG. 4B is a cross-sectional view of the link of FIG. 4A;

FIG. 5A shows side, top and back views of a doughnut hole injector manifold with injectors;

FIG. 5B shows an exploded view of a doughnut hole injector manifold with injectors;

FIG. 6A shows a partial view of a doughnut hole injector system;

FIG. 6B shows a partial rear view of a doughnut hole filling system; and

FIGS. 7A and 7B show views of a culling bar.

### DETAILED DESCRIPTION

In the following description, certain specific details are set forth in order to provide a thorough understanding of various disclosed embodiments. However, one skilled in the relevant art will recognize that embodiments may be practiced without one or more of these specific details.

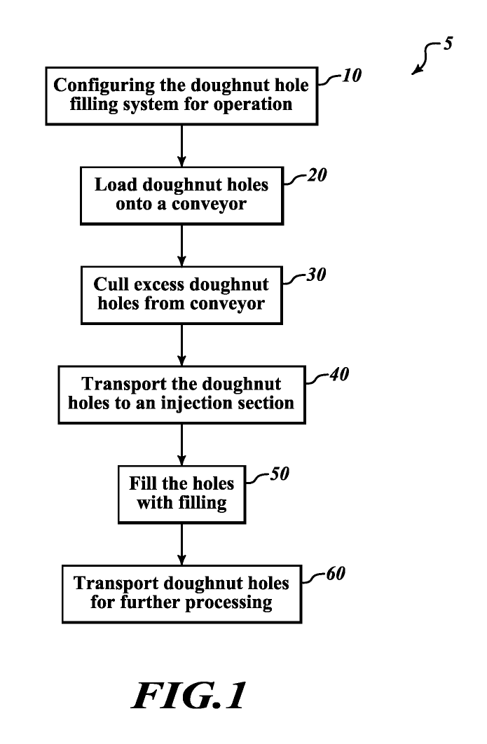

FIG. 1 shows a flow chart of one embodiment of a process for filling doughnut holes 5. The process may include the step of preparing a doughnut hole filling system for operation 10. This may include tasks such as configuring the volume of filling the system injects into the doughnut holes. This step may also include the step of configuring the travel limits, including the upper and lower travel limits of the injectors. By adjusting the upper and lower travel limits of the injectors, the baker can configure the system to work with various sized doughnut holes. In some embodiments, this step may also include configuring the desired injection location within the doughnut holes. For example, the location of the center of a doughnut hole depends on the size of the doughnut hole.

The process 5 may include the step of loading doughnut holes onto a conveyor 20. In this step, a baker may load doughnut holes into a feeding device that feeds the doughnut holes onto a conveyor. In some embodiments, the feeding device may be a hopper, a tray, or an inclined ramp. In some embodiments, the baker may load the doughnuts directly into cups on a conveyor, while in other embodiments the feeding device may facilitate loading the doughnut holes into cups.

The process 5 may include the step of culling excess doughnut holes from the conveyor 30. The baker may cull the doughnuts by visually inspecting the conveyor and removing excess doughnuts. In some embodiments, the culling process uses a culling bar to knock excess doughnut holes off the conveyor or out of the cups. The process may also include rotating the culling bar in a direction opposite to the direction of movement of the conveyor or cups.

The process 5 may include the step of transporting the doughnut holes to an injector system 40. This step may include the process of conveying the doughnut holes from one location, such as a loading or culling location, to a location for injecting the doughnut holes with filling.

In some embodiments, the transporting step includes a quality control step. In some embodiments of a quality control step, the process includes inspecting the quality of the doughnut holes and removing doughnut holes that do not meet a baker's quality standards. In some embodiments, the quality control process includes inspecting the conveyor and adding doughnut holes in places that are missing doughnut holes, such as empty cups, and removing doughnut holes from places that have excess doughnut holes, such as when a cup has more than one doughnut hole in it.

The process 5 may include the step of filling doughnut holes with filling 50. In some embodiments, the step of filling a doughnut hole with filling includes the step of injecting filling into the doughnut holes. In some embodiments, this step includes the additional step of pausing the movement of a conveyor when a doughnut hole is near the injector system. In other embodiments, the conveyor may not come to a complete stop, but the injection process is configured to begin when a doughnut hole approaches the injector system.

The filling step 50 may also include the steps of inserting a needle into a doughnut hole and injecting a filling into the doughnut hole. After the system fills the doughnut hole, it may unpause the movement of the conveyor.

The process 5 may include the step of transporting the doughnut holes for further processing 60. The step of transporting the doughnut holes for further processing may include depositing the doughnut holes into containers for sale, storage, or further transport. In some embodiments, the step may include additional transportation or conveyance to downstream equipment for additional processing, such as, for example, sugar coating.

The process 5 may occur in the order of the steps recited above or the process may occur in another order. In some embodiments, some steps may be omitted from the process. Additional steps and embodiments are also described below.

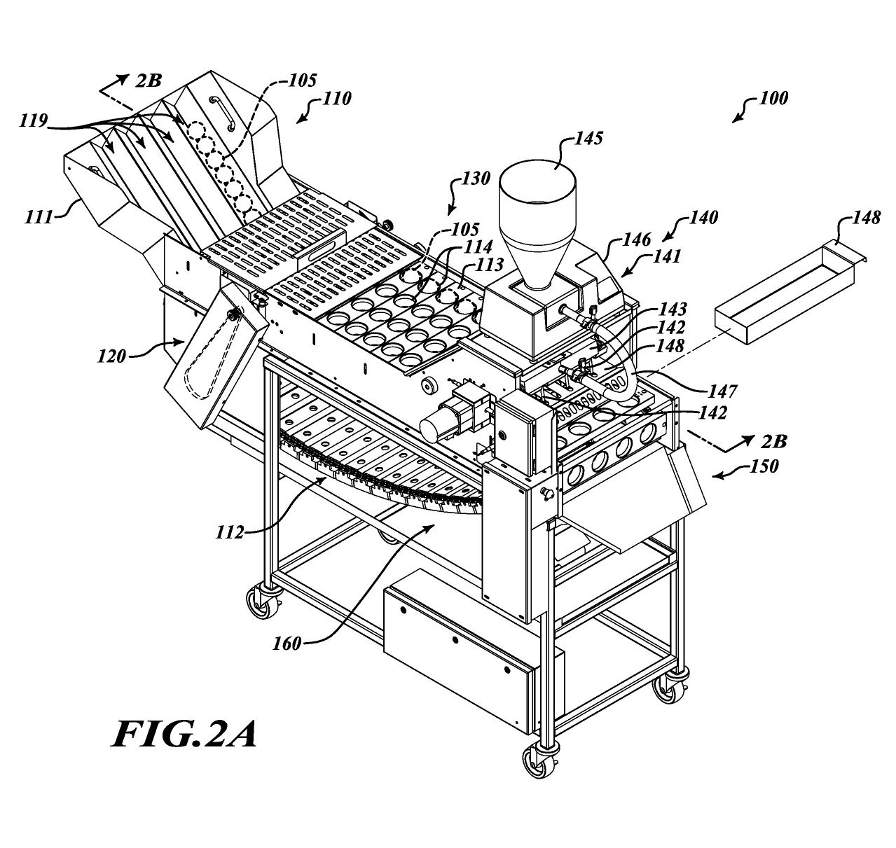

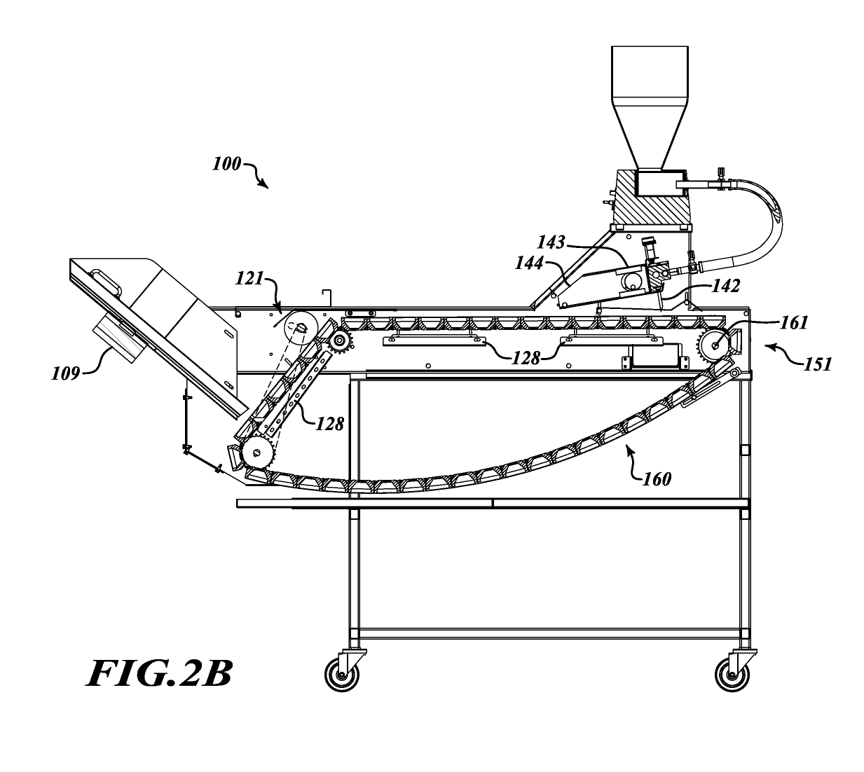

FIGS. 2A and 2B show a preferred embodiment of an automated doughnut hole filling system 100. The filling system 100 includes a loading section 110, a culling section 120, a quality control section 130, an injection section 140, an unloading section 150, and a conveyor system.

During operation, a baker loads doughnut holes into the loading section 110. The system then feeds the doughnut holes into the rest of the machine. In one embodiment, the system feeds the doughnut holes onto a conveyor system 160 and transports them to the culling section 120.

The conveyor system 160 includes a conveyor 112 made up of a plurality of individual links 113 coupled together to form a belt. The conveyor may also include a drive system. For example, the embodiment of FIGS. 2A and 2B show a drive system that includes a motor 161 coupled to the conveyor 112.

In the culling section 120 a culling system 121 operates such that it helps prevent the conveyor belt from being overloaded. In one embodiment, the culling system 121 may prevent more than one layer of doughnut holes from passing beyond the culling system 121. In such an embodiment, once a section of conveyor 112 passes the culling system 121, the conveyor should only have a single layer of doughnut holes. After the culling section 120, the conveyor carries the doughnut holes to a quality control section.

The quality control section 130 of the doughnut hole filling system 100 provides a space for a baker to check the quality of the product and check for proper arrangement of the doughnut holes on the conveyor. If the baker sees any problems, they can correct them before the doughnut holes enter the injection section 140.

In the injection section 140, injectors pierce the doughnut hole and then fill the doughnut holes with a filling. Finally, the conveyor 112 transports the doughnut holes from the injection section 140 to the unloading section 150.

In the unloading section 150, the conveyor may deliver the doughnut holes to another conveyor for transport and additional handling, a container for storage, or directly into packaging for sale.

Each section will now be described in greater detail. The loading section may include a structure for holding or temporarily storing the unfilled doughnut holes. The means may include a hopper, a silo, a conveyor belt, or an inclined plane or ramp. The loading section 110 of the doughnut hole filling system 100 includes a contoured ramp 111 for holding and dispensing the unfilled doughnut holes.

During operation, a baker unloads or dumps the unfilled doughnut holes 105 onto the ramp 111. Each doughnut hole then rolls down into one of the channels 119 and down the ramp 111 where the conveyor system 160 picks it up.

As shown in FIG. 2A, the ramp 111 may be contoured to include four channels 119. In a preferred embodiment, the channels of the ramp align with cups on a conveyor. For example, as shown in FIG. 2A, each of the four channels 119 of the ramp 111 aligns with one of the four cups 114 of the conveyor 112. By aligning each channel with a cup, the cups of the conveyor may easily pick up a doughnut hole as it travels past the end of the ramp. In some embodiments the ramp 111 may include more than four channels 119 or less than four channels 119. Some embodiments may include more than four cups 114 or less than four cups 114 on each link 113 of the conveyor 112. In some embodiments the number of cups 114 on a link 113 may be the same as the number of channels 119 on the ramp 111. In some embodiments, the number of channels 110 on the ramp 111 may be more or less than the number of cups 114 on each link 113. In some embodiments, the ramp 110 may be flat. In such embodiments the ramp 119 may not have any channels 119.

The loading section 110 may also include a vibratory system 109. The vibratory system 109 may include a motor with an unbalanced load that causes the ramp 111 and doughnut holes 105 to vibrate. The vibration may aid in loading the conveyor with doughnut holes.

Because the baker may dump large quantities of doughnut holes onto the ramp 111, the holes may pile up against the conveyor 112 and overload the conveyor 112 or overfill the cups 114. By inclining the conveyor in the loading section 110, the doughnut holes that are not contained in a cup or are otherwise overloading the conveyor are encouraged by gravity to roll down the incline of the conveyor 112 and back onto the ramp 111 where they wait until the conveyor has capacity to load the holes.

Simply inclining the conveyor in the loading section does not guarantee that the conveyor does not get overloaded, nor does it ensure that a single doughnut hole is loaded into each cup. Therefore, a filling system may include a culling section. For example, filling system 100 includes a culling section 120. The culling section may include a culling system that helps prevent the conveyor from getting overloaded with doughnut holes. In some embodiments, the culling system may include a stationary bar that knocks excess doughnut holes off the conveyor and back down to the ramp.

In some embodiments, the culling system 121 may include a culling bar 122. Shown in more detail in FIG. 3, the culling system 121 includes a rotating culling bar 122, a drive unit 123, and a drive chain or belt 124. The culling system 121 works in conjunction with the conveyor 112 and the cups 114 to cull excess doughnut holes by rotating the culling bar 122 in a direction counter to the movement of the conveyor 112. The counter movement causes the culling bar 122 to knock extra doughnut holes off the conveyor 112 and back down to the ramp 111.

The drive unit 123 may rotate the culling bar 122 and also move the conveyor 123. In some embodiments the drive unit 123 may only drive the culling bar and a second motor, such as motor 161 may move the conveyor.

The culling bar may have a length that substantially spans the width of the injector system or, more particularly, the width of the conveyor. As shown in FIGS. 7A and 7B, the culling bar 122 may also have a paddle 125 that extends radially outward from a rotational axis of the culling bar. In some embodiments, the paddle 125 extends the width of the injector system. In other embodiments, the culling bar 122 may include a plurality of paddles that extend from a rotational axis of the culling bar with each paddle located along the length of the culling bar such that it aligns with the location of the doughnut holes or cups on the conveyor.

In some embodiments, the culling bar's rotation can be linked to the movement of the conveyor. In such embodiments, the rotation of the culling bar may be timed with the movement of the conveyor such that a paddle sweeps over a cup 114 or doughnut hole location one or more times as the cup 114 or doughnut hole location passes by the culling bar.

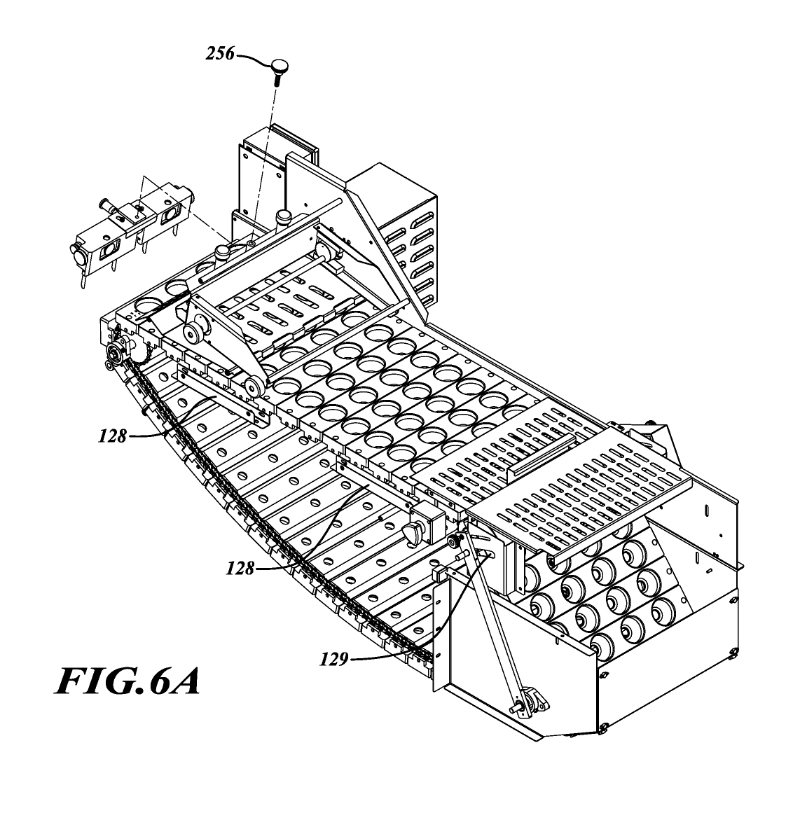

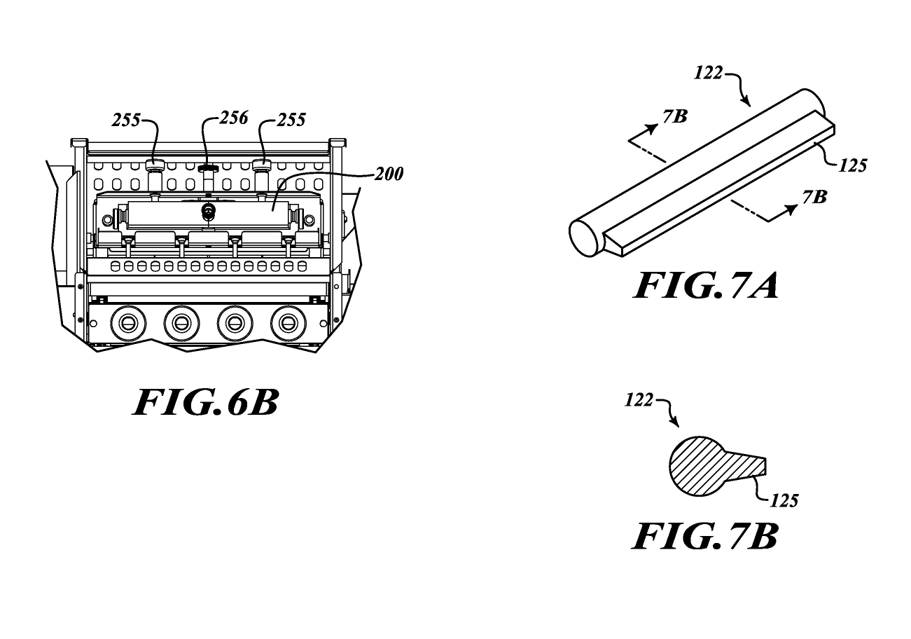

The culling bar 122 may be set at a selected height above the conveyor. In some embodiments, the height may be adjusted by raising or lowering the ends of the culling bar's 122 position within slots 129 (see FIG. 6).

In some embodiments, for example, as shown in FIGS. 1-3, the culling bar 122 may include a culling brush 126. The culling brush 126 may have a length that substantially spans the width of the injector system or, more particularly, the width of the conveyor 112. The culling brush 126 may have a plurality of bristles that extends radially outward from a central shaft of the culling brush 126. In use, the culling brush 126 rotates counter to the movement of the conveyor 112. The counter movement causes the bristles of the culling brush 126 to knock extra doughnut holes off the conveyor 112 and back down to the ramp 111.

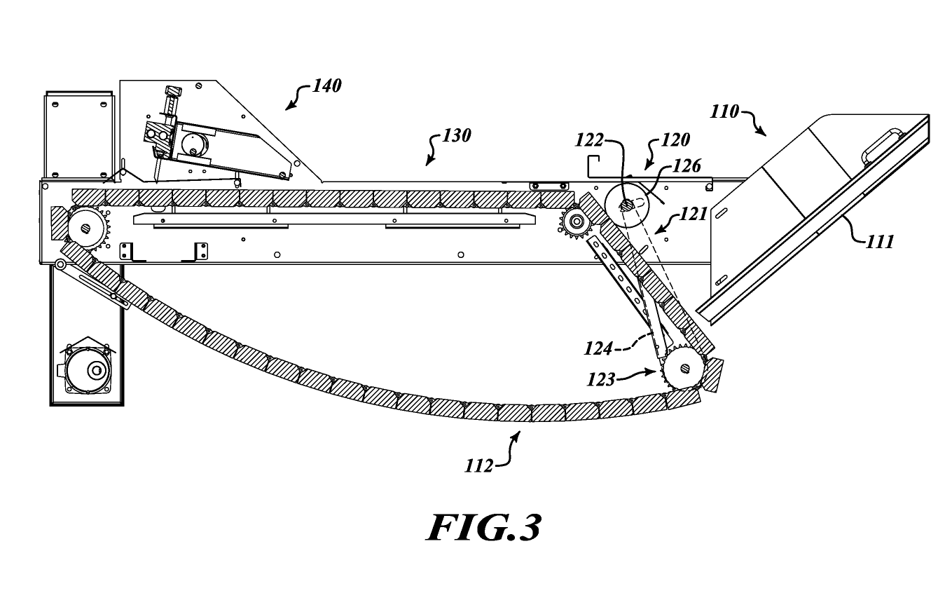

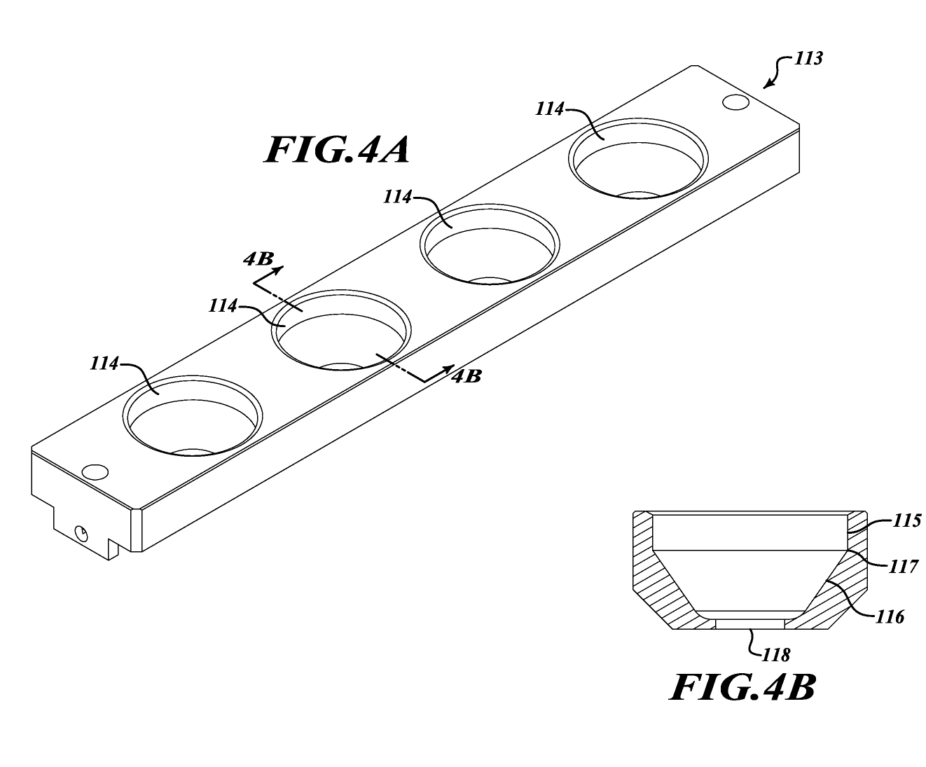

In some embodiments, the conveyor includes a plurality of links, for example links 113, shown in more detail in FIGS. 4A and 4B. Each link may include one or more cups 114 for holding doughnut holes. The design of the cups 114 may aid in the culling process. In some embodiments, the cup may have sidewalls with varying contours. For example, the cups 114 have two differently contoured sections 115, 116. The lower section 116 has a substantially conical shape. The substantially conical shape encourages the doughnut hole to sit in the center of the bottom of the cup 114 when the link 113 is horizontal, for example, when the link 113 is in the quality control section 130. In some embodiments, the lower section may be spherically shaped or in another shape that encourages the doughnut hole to sit in the center of the bottom of the cup when the link is horizontal.

The upper section 115 has a substantially cylindrical shape. The substantially cylindrical shape aids in preventing the doughnut hole from rolling out of the cup when the link 113 is inclined, for example when the link 113 is traveling up through the loading and culling sections 110, 120. In some embodiments, the upper section may be conical or spherically shaped with a wall contour that aids in preventing the doughnut hole from rolling out of the cup when the link 113 is inclined. For example, the upper section's wall may be inclined, but at an angle less than that of the lower section, or the upper section's wall may be spherically shaped with a surface shape that aids in preventing the doughnut hole from rolling out of the cup when the link 113 is inclined.

In embodiments of a cup with two sections, the sections may be discontinuous, for example, as shown in the cup 114. In such embodiments, the two sections may intersect at an apex at their point of intersection 117. In some embodiments of a cup with two sections, the sections may be continuous rather than discontinuous. In embodiments with two continuous sections, the two sections may have a common surface tangent or surface normal at the point of intersection 117.

In some embodiments, the cup may have only one section. In such embodiments, for example, the cup may have a substantially spherical shape with its equatorial plane at a point of intersection 117.

In some embodiments, the depth of the cup is substantially similar to the diameter of the baker's doughnut holes. For example, in an embodiment made for 1.5 inch diameter doughnut holes, the depth of the cup may be approximately 1.5 inches. In such an embodiment, the depth of the upper section is approximately 0.5 inches and the depth of the lower section is approximately 1 inch.

The depth of the cup may be selected such that only one doughnut hole may fit within the cup. Should two doughnut holes fall into the cup and become overloaded, the first doughnut hole will sit within the cup, while the second doughnut hole may protrude out the top of the cup. As the overloaded cup passes the culling bar 122, the culling bar 122 may contact the protruding doughnut hole and knock it out of the cup 114. Once knocked out of the cup 114, the doughnut hole may fall down onto the ramp 111 where it will sit until an empty cup 114 passes by and scoops it up.

The cup may also include an aperture 118 at its bottom. The aperture 118 may also help center the doughnut hole within the cup. As discussed below with respect to the injection section, the aperture 118 may also help keep the links clean. For example, when an empty cup enters the injection section, the injector may still attempt to inject filling into the cup, even without a doughnut hole. The aperture 118 allows the excess filling that would otherwise collect in the bottom of the cup to simply fall through the aperture and into a catch tray 148 rather than collecting in the empty cup.

While the embodiment of the cups 114 in FIGS. 4A and 4B include cups disposed within the link 113, in some embodiments, the cup may protrude from the surface of the link.

After traveling though the culling section 120, the conveyor 112 moves the link 113 to and through the quality control section 130. In the quality control section 130, a baker checks each doughnut hole to make sure it meets their standards. If a doughnut hole does not meet their standards, then the baker may remove the lower quality doughnut hole from its cup and replace it with a quality doughnut hole.

The quality control section 130 also provides the baker an opportunity to verify that each cup has a single doughnut hole inside of it. In the case where a cup is empty, the baker may fill the cup by hand, for example by taking a doughnut hole directly from the loading section. In the case where a cup has more than one doughnut hole in it, the baker may remove the excess holes and put them in the loading section.

After the doughnut holes finish with the quality control section 130, the conveyer takes them to the injection section 140. In the injection section 140, the injector system 141 injects the doughnut holes with a filling.

Referring to FIGS. 2A and 2B, the injector system 141 may include several components including a filler storage unit 145, a volumetric dosing system 146, a manifold supply line 147, a manifold 143, a pivot arm 144, and a plurality of needles 142. The storage unit 145 holds the filling for the doughnut holes and supplies it to the volumetric dosing system 146. In the embodiment of FIGS. 2A and 2B, the storage unit 145 is a gravity fed hopper.

The baker configures the volumetric dosing system 146 to dispense a selected volume of filling into each doughnut hole. For example, when processing large doughnut holes, the baker configures the volumetric dosing system 146 to dispense a relatively large amount of filling into each doughnut hole, and when processing smaller doughnut holes, to dispense a relatively small amount of filling.

The volumetric dosing system 146 pumps filling through the manifold supply line 147, into the manifold 143, then into the needles 142, and finally, into the doughnut holes.

The injection process may proceed through in a number of steps. First, the conveyor 112 moves the links 113 until a link 113 is located under the needles 142 of the injector system 141. In some embodiments, the system may use a proximity switch or limit switch to indicate that a link is located under the needles 142. Then, when a link 113 is located under the needles 142, the system pauses the conveyor's 112 movement.

With the conveyor 112 paused, the system inserts the injector needles 142 into the doughnut holes. In some embodiments, for example, as shown in FIG. 2B, the injector needles 142 are coupled to a manifold 143 which is coupled to a pivot arm. The system inserts the needles 142 into the doughnut holes by pivoting the pivot arm 144 in a direction that lowers the manifold 143. As the system lowers the pivot arm 144, the needles 142 pierce the doughnut holes. With the needles 142 inserted into to the doughnut holes, the system initiates the injection process and fills the doughnut holes with filling.

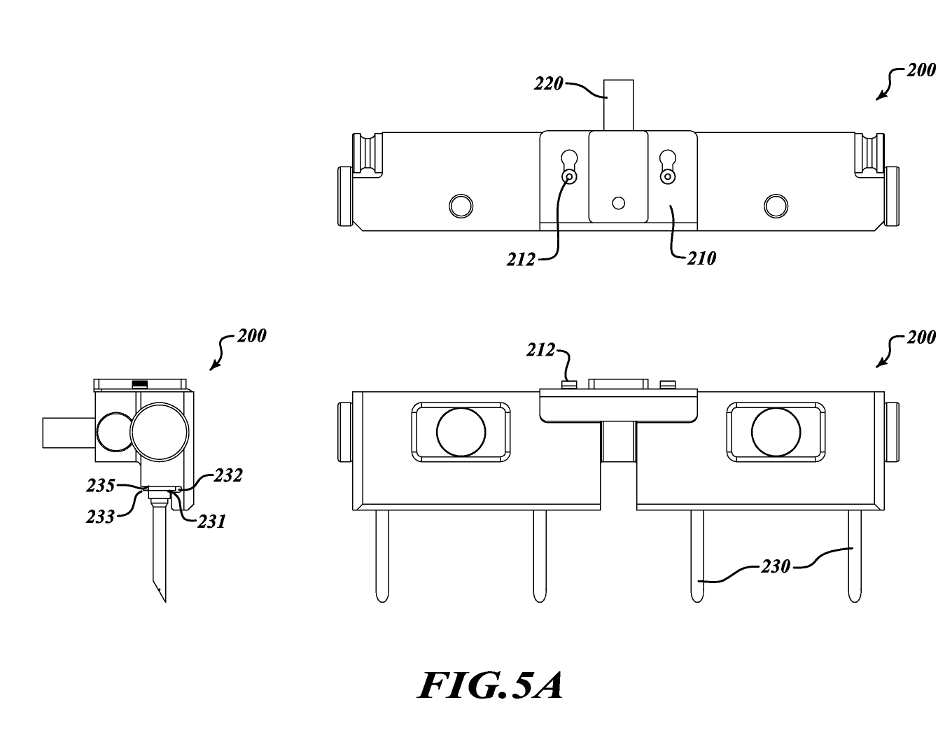

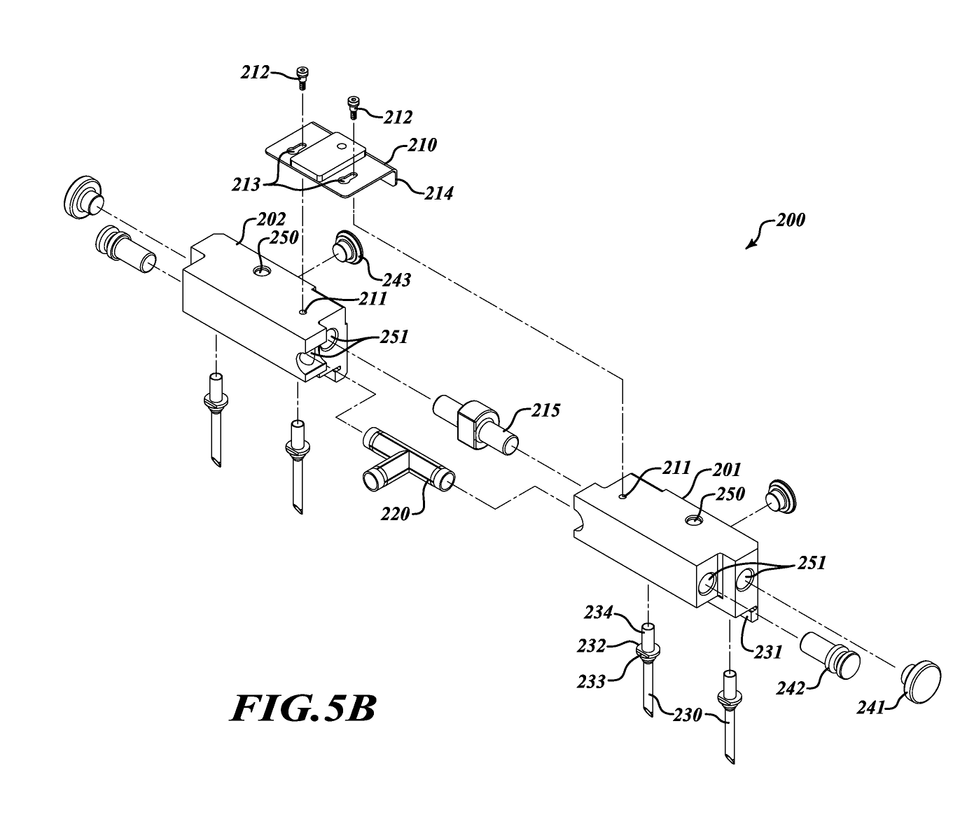

FIG. 5A shows top, side, and back views of an injector manifold assembly. FIG. 5B shows an exploded view of an injector manifold assembly. The illustrated injector manifold assembly 200 includes to manifold halves 201, 202. The two manifold halves 201, 202 couple together via coupler 210 and fasteners 212. The fasteners may be thumb screws to allow for easy tool free assembly and disassembly of the manifold. The bracket 210 fits over the a portion of the tops of the two manifold halves 201, 202 and the thumb screws 212 pass through the apertures 213 of the bracket 210 and engage in a respective hole 211 in each of the two manifold halves 201, 202. The bracket 210 may also include an alignment surface 214 to keep the two manifold halves 201, 202 aligned with each other.

The manifold tubes 251 maintain fluid communication between the two halves 201, 202 via junction 215 and filling inlet tee 220. In some embodiments, the junction 215 is hollow to allow fluid to pass through or may be solid to prevent fluid from passing. The manifold 200 may also include access plugs 241, 242, 243 that releasably engage with the manifold tubes 251 to allow for easy cleaning of the interior of the manifold, including the manifold tubes 251. The manifold may be cleaned with one or more of water, soap, degreaser, and other cleaning agents.

The manifold halves 201, 202 may also include a channel 231 that engages with a retention collar 232 of needles 230. The collar 232 includes a notch 233. To insert the needles into a manifold half 201, 202, the needle inlet end 234 is inserted into a manifold aperture 235 that is in fluid communication with the manifold tubes 251 with the notch 233 aligned with the channel 231. When the needle 230 is fully inserted into the manifold 201, 202. The needle 230 may be rotated such that the collar engages with the channel 231 and thereby retaining the needle 230 in the manifold 201, 202.

The pivot arm 144 and the injector system 141 include a pivot adjustment system, for example, configurable limit switches, which allow the baker to adjust the motion of the pivot arm for use with various sized doughnut holes. This adjustment system allows the system to fill large doughnut holes by configuring the pivot arm 144 to retract into a higher position when the conveyor is moving. This positions the needles out of the way of the moving doughnut holes. The baker may also adjust the lower end of the pivot arm's 144 travel so that it positions the needles 142 at a desired location within the doughnut hole. In some embodiments, a desired location within the doughnut holes may be at or near the center of the doughnut hole. After the system fills the doughnut holes, the system removes the needles 142 from the doughnut holes and the system unpauses the conveyor 112.

In some embodiments, the travel of the pivot arms and injection needles may be adjusted using a threaded adjustment mechanism. For example, adjuster 256 includes a threaded stud that, by turning the stud, adjusts the height of the manifold, and thus the injection needles 142. The adjustment mechanism may also include adjusters 255. These adjusters 255 may also be threaded studs. The adjusters 255 act on the manifold 200 and level the manifold 200 with respect to the conveying means, for example, conveyor 112. In some embodiments, the adjusters 255 act on the manifold 200 by pushing against the manifold 200 at the intentions 250 (see FIG. 5B). In some embodiments, the indentions 250 may not be necessary and the adjusters 255 may act against the surface of the manifold 200.

In some embodiments, the conveyor 112 may also be adjustable. For example, as portions of the conveyor 112, for example, the links 113, enter the injection section 140, their height may change. In some embodiments, the height of the links 113 and/or conveyor 112 may be adjustable via chain guides 128. The chain guides 128 act on the conveyor 112 and/or the links 113 to raise or lower the conveyor 112 or links 113 in a given section of the filling machine 100. To raise the conveyor 112 or links 113, the chain guides 128 are raised, to lower the conveyor 112 or links 113, the chain guides 128 are lowered. In some embodiments, other adjustment mean may be used to adjust the height of a conveyor or links in a filling system.

In the case where a cup 114 is empty while in the injection section 140, the injector system 141 may still attempt to inject filling, notwithstanding the fact that there is no doughnut hole for filling. In such circumstances, the filling drops through an aperture 118 in the cup 114 and the system may collect the excess filling. In some embodiments, the system collects the filling in a removable tray, for example, removable tray 148, shown in a removed position in FIG. 2A.

At this point, the conveyer 112 begins moving again. The conveyor 112 will continue to move until the next link 113 is located under the needles 142, and the process repeats itself.

The conveyer will continue to transport the filled doughnut holes from the injection section 140 to the unloading section 150. In the unloading section 150, the baker unloads the filled doughnut holes. In some embodiments, the baker allows the doughnut holes to fall out of the cups 114 as the link 113 moves around the end 151 of the horizontal conveyor section. In some embodiments, the filled doughnut holes fall directly into packaging for retail or wholesale sale. In some embodiments, the doughnut holes drop onto another conveyor or additional downstream handling equipment for additional processing, such as, for example, sugar coating. In some embodiments, the doughnut holes leave the conveyor and the baker stores them for future processing.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for filling doughnut holes, the system comprising:
a conveyor system that transports doughnut holes between at least a loading section, a culling section, and an injection section;
the conveyor system including a plurality of links coupled together to form a belt;
the loading section including a feeding device that feeds doughnut holes onto the conveyor system;
the culling section including a culling bar that culls excess doughnut holes from the conveyor; and
the injection section including an injector system that injects feeds doughnut holes with a filling.

2. The system for filling doughnut holes of claim 1, further comprising a quality control section disposed between the culling section and the injection section.

3. The system for filling doughnut holes of claim 1, further comprising a cup disposed within the links, the cup including an upper section with a cylindrical shape and a lower section with a conical shape.

4. A method of filling a doughnut hole, the method comprising:
configuring a doughnut hole filling machine for operation;
loading doughnut holes onto a conveyor;
culling excess doughnut holes from the conveyor;
transporting the doughnut holes to an injection section; and
filling the doughnut holes with filling.

5. The method of filling a doughnut hole of claim 4, wherein the step of configuring the doughnut hole filling machine for operation includes the steps of:
configuring an injector system to fill the doughnut holes at an injection location; and
configuring the injector system to fill the doughnut holes with a predetermined amount of filling.

6. The method of filling a doughnut hole of claim 4, wherein the step of culling excess doughnut holes from the conveyor further includes the steps of:
moving a culling bar to remove excess doughnut holes from the conveyor.

7. The method of filling a doughnut hole of claim 4, wherein the step of culling excess doughnut holes from the conveyor further includes the steps of:
rotating a culling brush to remove excess doughnut holes from the conveyor.

8. A method of cleaning a doughnut hole filling machine, the method comprising:
removing an injection manifold from the filling machine, the injection manifold including a first half and a second half joined together by a coupler, the first half including a first distribution tube and the second half including a second distribution tube, the first and second distribution tubes releasably coupled in fluid communication with each other, the first and second distribution tubes configured to couple, in fluid communication, a manifold inlet to an injection needle, the first distribution tube and the second distribution tube including a plurality of access plugs each releasably engaged with a respective access hole of a distribution tube, the injection needle releasably coupled to the injection manifold;
disconnecting the coupler from at least one of the first and second halves;
separating the first half of the manifold from the second half of the manifold;
disengaging at least one of a plurality of access plugs from the respective access hole;
cleaning the manifold and distribution tubes.

9. The method of cleaning a doughnut hole filling machine of claim 8 wherein the step of separating the first half of the manifold from the second half of the manifold includes:
separating the first half of the manifold from the second half of the manifold such that the first and second distribution tubes are not in fluid communication with each other.

10. The method of cleaning a doughnut hole filling machine of claim 8 wherein the coupler is a coupling plate.

11. The method of cleaning a doughnut hole filling machine of claim 8, further comprising:
decoupling the injection needle from the injection manifold.

12. The method of cleaning a doughnut hole filling machine of claim 11, wherein decoupling the injection needle from the injection manifold includes rotating the injection needle until a notch of a needle collar aligns with a channel of the injection manifold.
